(19) United States
(12) Patent Application Publication
(10) Pub. No.: US 2022/0263356 A1
(43) Pub. Date: Aug. 18, 2022

(54) MOTOR

(71) Applicant: Komatsu Ltd., Tokyo (JP)

(72) Inventors: Hiroki Hijikata, Tokyo (JP); Natsuki Watanabe, Tokyo (JP); Teiichirou Chiba, Tokyo (JP)

(73) Assignee: Komatsu Ltd., Tokyo (JP)

(21) Appl. No.: 17/626,589

(22) PCT Filed: Aug. 20, 2020
(86) PCT No.: PCT/JP2020/031447

§ 371 Date: Jan. 12, 2022

(30) Foreign Application Priority Data
Aug. 29, 2019 (JP) 2019-157089

(51) Int. Cl. H02K 1/16; H02K 3/12; H02K 15/06; H02K 1/24

(52) U.S. Cl. CPC H02K 1/16; H02K 3/12; H02K 2213/03; H02K 1/24; H02K 15/06

(57) ABSTRACT

A motor includes a stator core, a coil disposed in slots of the stator core, and a rotor facing the stator core. When the number of poles of the rotor is P, the number of the slots of the stator core is S, and a natural number is N, conditions of P=7×N and S=12×N are satisfied.

### FIELD

The present disclosure relates to a motor.

### BACKGROUND

A motor includes a stator and a rotor. The stator has a stator core and a coil. An example of a stator structure is disclosed in Patent Literature 1.

### CITATION LIST

### Patent Literature

Patent Literature 1: JP 2011-010392 A

### SUMMARY

### Technical Problem

As a winding method of a coil, full-pitch winding and short-pitch winding are known. The full-pitch winding refers to a winding method in which a pole pitch of the rotor and a coil pitch of the stator are equal. The short-pitch winding refers to a winding method in which a coil pitch of the stator is smaller than a pole pitch of the rotor. For example, in a case where a coil of a switched reluctance motor is wound in full-pitch winding, the torque per unit volume of the stator in a full-pitch winding motor is larger than that in a short-pitch winding motor. However, in the motor with full-pitch winding, a coil end becomes larger than that of the motor with short-pitch winding, and a significant improvement in the torque density of the motor cannot be expected. In addition, depending on the structure of the stator, if a split stator core is not adopted, it may be difficult to insert a molded coil into a slot of the stator core.

An object of the present disclosure is to provide a motor that can suppress the size of a coil end portion and can be easily assembled without adopting a split stator core.

### Solution to Problem

According to an aspect of the present invention, a motor comprises: a stator core; a coil disposed in slots of the stator core; and a rotor facing the stator core, wherein, when the number of poles of the rotor is P, the number of slots of the stator core is S, and a natural number is N, the following conditions are satisfied: P=7×N, S=12×N.

### Advantageous Effects of Invention

According to the present disclosure, there is provided a motor that can suppress the size of the coil end portion and can be easily assembled without adopting the split stator core.

### BRIEF DESCRIPTION OF DRAWINGS

FIG. 1 is a diagram schematically illustrating a motor according to the present embodiment.

FIG. 2 is a perspective view illustrating a part of the stator according to the present embodiment.

FIG. 3 is a diagram schematically illustrating a stator and a rotor according to the present embodiment.

FIG. 4 is a diagram schematically illustrating teeth and coils according to the present embodiment.

FIG. 5 is a flowchart illustrating an example of a method of manufacturing a stator according to the present embodiment.

FIG. 6 is a diagram schematically illustrating a slot according to the present embodiment.

### DESCRIPTION OF EMBODIMENTS

Hereinafter, embodiments according to the present disclosure will be described with reference to the drawings, but the present invention is not limited thereto. The components of the embodiments described below can be appropriately combined. In addition, some components may not be used.

[Motor]

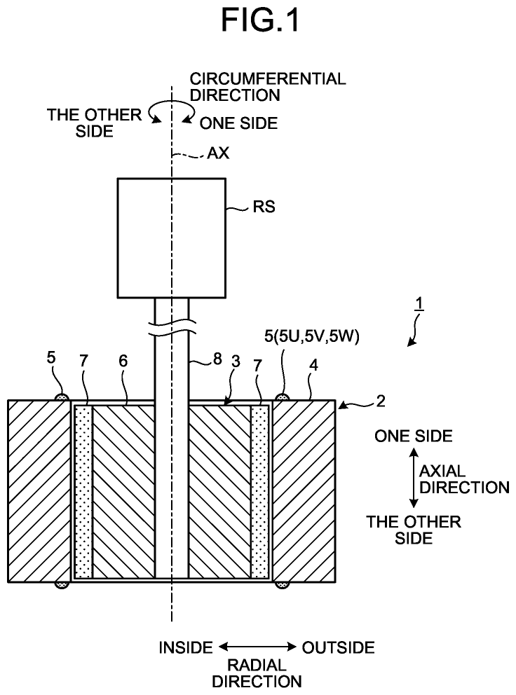

FIG. 1 is a diagram schematically illustrating a motor 1 according to the present embodiment. In the present embodiment, the motor 1 is a segment-type switched reluctance motor. As illustrated in FIG. 1, the motor 1 includes a stator 2 and a rotor 3.

The stator 2 is substantially cylindrical. An inner peripheral surface of the stator 2 and an outer peripheral surface of the rotor 3 face each other with a gap interposed therebetween. The rotor 3 rotates about a rotation axis AX. The rotation axis AX of the rotor 3 substantially coincides with a central axis of the stator 2.

In the present embodiment, a direction parallel to the rotation axis AX is appropriately referred to as an axial direction, a direction around the rotation axis AX is appropriately referred to as a circumferential direction, and a radiation direction of the rotation axis AX is appropriately referred to as a radial direction.

Furthermore, in the axial direction, a direction or a position away from the center of the motor 1 in a prescribed direction is appropriately referred to as one side in the axial direction, and in the axial direction, an opposite side of one side in the axial direction is appropriately referred to as the other side in the axial direction. In addition, in the circumferential direction, a prescribed rotation direction is appropriately referred to as one side in the circumferential direction, and in the circumferential direction, an opposite side of one side in the circumferential direction is appropriately referred to as the other side in the circumferential direction. Further, in the radial direction, a direction or a position away from the central axis AX is appropriately referred to as an outside in the radial direction, and in the radial direction, an opposite side of the outside in the radial direction is appropriately referred to as an inside in the radial direction.

The stator 2 has a stator core 4 and a coil 5 supported by the stator core 4. The rotor 3 is disposed so as to face the stator core 4. In the present embodiment, the rotor 3 is disposed inside the stator core 4. The rotor 3 has a rotor holder 6 and a rotor core piece 7 held by the rotor holder 6. The rotor holder 6 is a non-magnetic body. The rotor core piece 7 is a magnetic body. The rotor core piece 7 functions as a pole of the rotor 3.

The motor 1 is a three-phase motor. The coil 5 includes a U-phase coil 5U, a V-phase coil 5V, and a W-phase coil 5W.

The rotor 3 is connected to an object RS via a shaft 8. As the object RS, an engine mounted on a hybrid excavator which is a kind of construction machine is exemplified. The motor 1 functions as a generator driven by the engine.

[Stator]

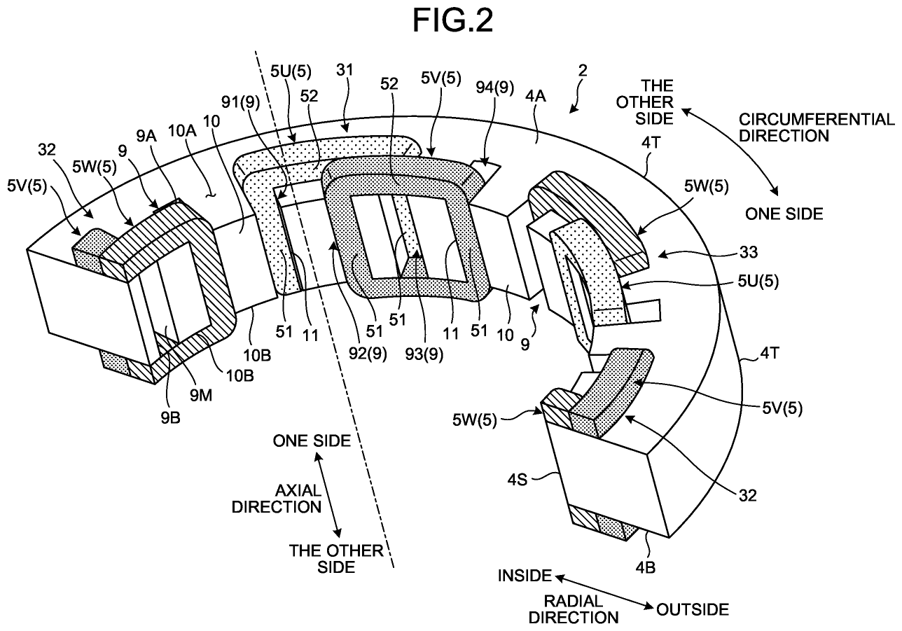

FIG. 2 is a perspective view illustrating a part of the stator 2 according to the present embodiment. As illustrated in FIG. 2, the stator 2 has the stator core 4 and the coil 5 disposed in a slot 9 of the stator core 4.

The stator core 4 has an inner peripheral surface 4S, an outer peripheral surface 4T, a first end surface 4A, and a second end surface 4B. The inner peripheral surface 4S faces radially inward. The outer peripheral surface 4T faces radially outward. The first end surface 4A faces one side in the axial direction. The second end surface 4B faces the other side in the axial direction. The first end surface 4A connects an end on one side in the axial direction of the inner peripheral surface 4S with an end on one side in the axial direction of the outer peripheral surface 4T. The second end surface 4B connects an end on the other side in the axial direction of the inner peripheral surface 4S with an end on the other side in the axial direction of the outer peripheral surface 4T.

A plurality of slots 9 are provided in the circumferential direction on the inner peripheral surface 4S. The slot 9 is recessed radially outward from the inner peripheral surface 4S. The slot 9 extends in the axial direction. The slot 9 has an opening portion 9M provided on the inner peripheral surface 4S and facing radially inward, an opening portion 9A provided on the first end surface 4A and facing one side in the axial direction, and an opening portion 9B provided on the second end surface 4B and facing the other side in the axial direction.

Furthermore, the stator core 4 also has teeth 10 disposed between the slots 9 adjacent to each other in the circumferential direction.

The teeth 10 support the coil 5. The teeth 10 have an end surface 10A facing one side in the axial direction and an end surface 10B facing the other side in the axial direction. The first end surface 4A includes the end surface 10A. The second end surface 4B includes the end surface 10B.

The coil 5 is supported by the teeth 10. The coil 5 has an opening 11. The teeth 10 are inserted into the opening 11 of the coil 5. A part of the coil 5 is disposed inside the slot 9. A part of the coil 5 protrudes in the axial direction from the stator core 4.

In the following description, a portion of the coil 5 disposed inside the slot 9 will be appropriately referred to as a coil center portion 51, and a portion of the coil 5 protruding in the axial direction from the stator core 4 will be appropriately referred to as a coil end portion 52.

The coil 5 has two coil center portions 51. The coil 5 has two coil end portions 52. When one coil center portion 51 is disposed in a predetermined slot 9, the other coil center portion 51 is disposed in a slot 9 different from the slot 9 in which the one coil center portion 51 is disposed. The coil end portion 52 includes a first coil end portion 52 protruding to one side in the axial direction from the first end surface 4A of the stator core 4 and a second coil end portion 52 protruding to the other side in the axial direction from the second end surface 4B of the stator core 4.

As described above, the coil 5 includes the U-phase coil 5U, the V-phase coil 5V, and the W-phase coil 5W. FIG. 2 illustrates the U-phase coil 5U and the V-phase coil 5V.

As illustrated in FIG. 2, the U-phase coil 5U and the V-phase coil 5V overlap with each other. A coil set 31 of the U-phase coil 5U and the V-phase coil 5V is formed by overlapping the U-phase coil 5U with the V-phase coil 5V such that a part of the V-phase coil 5V is disposed between the U-phase coils 5U and a part of the U-phase coil 5U is disposed between the V-phase coils 5V.

Similarly to the coil set 31, the V-phase coil 5V and the W-phase coil 5W are overlapped such that a part of the W-phase coil 5W is disposed between the V-phase coils 5V and a part of the V-phase coil 5V is disposed between the W-phase coils 5W, whereby a coil set 32 of the V-phase coil 5V and the W-phase coil 5W is formed. A coil set 33 of the W-phase coil 5W and the U-phase coil 5U is formed by overlapping the W-phase coil 5W with the U-phase coil 5U such that a part of the U-phase coil 5U is disposed between the W-phase coils 5W and a part of the W-phase coil 5W is disposed between the U-phase coils 5U. The stator core 4 supports each of the coil set 31, the coil set 32, and the coil set 33.

The coils 5 are disposed around the teeth 10 at a pitch of two slots. That is, when one coil center portion 51 of the coil 5 is disposed in the predetermined slot 9, the other coil center portion 51 is disposed in a slot 9 that is two slots away from the slot 9 in which one coil center portion 51 is disposed in the circumferential direction.

In the example illustrated in FIG. 2, the slot 9 includes a first slot 91, a second slot 92 disposed adjacent to one side in the circumferential direction of the first slot 91, a third slot 93 disposed adjacent to one side in the circumferential direction of the second slot 92, and a fourth slot 94 disposed adjacent to one side in the circumferential direction of the third slot 93.

The other coil center portion 51 of the U-phase coil 5U is disposed in the first slot 91. The other coil center portion 51 of the V-phase coil 5V is disposed in the second slot 92. One coil center portion 51 of the U-phase coil 5U is disposed in the third slot 93. One coil center portion 51 of the V-phase coil 5V is disposed in the fourth slot 94.

A relationship between the V-phase coil 5V and the W-phase coil 5W of the coil set 32 and the plurality of slots 9, and a relationship between the W-phase coil 5W and the U-phase coil 5U of the coil set 33 and the plurality of slots 9 are similar to a relationship between the U-phase coil 5U and the V-phase coil 5V of the coil set 31 and the plurality of slots 9.

[Relationship Between the Number of Poles and the Number of Slots]

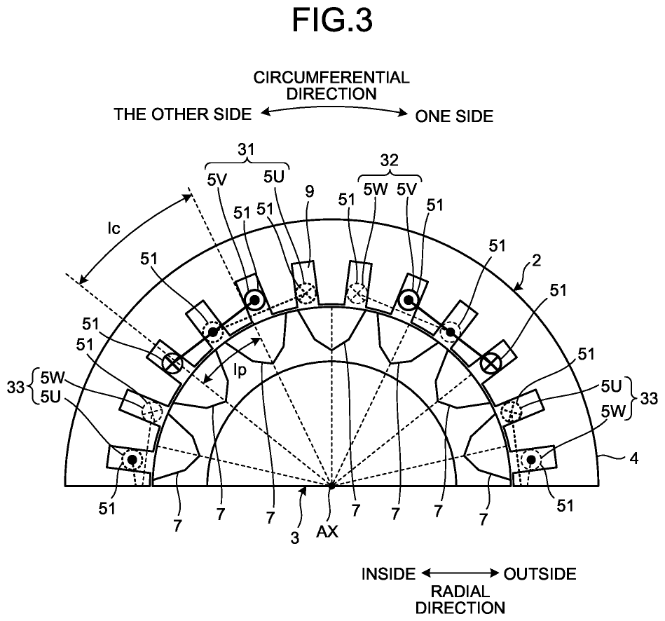

FIG. 3 is a diagram schematically illustrating the stator 2 and the rotor 3 according to the present embodiment. FIG. 3 illustrates the stator 2 and the rotor 3 divided in half. Note that the polarity of windings illustrated in FIG. 3 is an example. The polarity of the windings is also established in the direction illustrated in FIG. 3 or in the direction opposite to the direction illustrated in FIG. 3.

As illustrated in FIG. 3, each of the coil set 31 of the U-phase coil 5U and the V-phase coil 5V, the coil set 32 of the V-phase coil 5V and the W-phase coil 5W, and the coil set 33 of the W-phase coil 5W and the U-phase coil 5U is supported by the stator core 4. Each of the U-phase coil 5U, the V-phase coil 5V, and the W-phase coil 5W is disposed around the teeth 10 at a pitch of two slots.

The rotor 3 has a plurality of rotor core pieces 7. The shapes and dimensions of the plurality of rotor core pieces 7 are the same. The plurality of rotor core pieces 7 are disposed at equal intervals in the circumferential direction. The rotor core piece 7 functions as a pole of the rotor 3. The number of poles of the rotor 3 means the number of rotor core pieces 7.

In the present embodiment, when the number of poles of the rotor 3 is denoted by P, the number of slots of the stator core 4 is denoted by S, and a natural number is denoted by N, the motor 1 satisfies conditions of formulas (1) and (2) below.

P=7×N (1)

S=12×N (2)

That is, as the motor 1 according to the present embodiment, a motor with seven poles and 12 slots, a motor with 14 poles and 24 slots, and a motor with 21 poles and 36 slots are exemplified.

In the present embodiment, in the rotation of the rotor 3, the number of poles P and the number of slots S are determined such that at least two coil center portions 51 of the U-phase coil 5U, the V-phase coil 5V, and the W-phase coil 5W face two rotor core pieces 7 adjacent to each other in the circumferential direction. In the example illustrated in FIG. 3, the two coil center portions 51 of the V-phase coil 5V and the two rotor core pieces 7 adjacent to each other in the circumferential direction face each other at the same time. When the rotor 3 rotates, a state in which the two coil center portions 51 of the U-phase coil 5U and the two rotor core pieces 7 adjacent to each other in the circumferential direction face each other at the same time occurs. Further, when the rotor 3 rotates, a state in which the two coil center portions 51 of the W-phase coil 5W and the two rotor core pieces 7 adjacent to each other in the circumferential direction face each other at the same time occurs.

As described above, in the present embodiment, the number of poles P and the number of slots S are determined such that a coil pitch Ic of the U-phase coil 5U, a coil pitch Ic of the V-phase coil 5V, and a coil pitch Ic of the W-phase coil 5W are substantially equal to a pole pitch Ip of the rotor 3.

In the present embodiment, the coil pitch Ic refers to an angle formed by one coil center portion 51 and the other coil center portion 51 of one coil 5 on the basis of the rotation axis AX. The pole pitch Ip refers to an angle formed by the two rotor core pieces 7 adjacent to each other in the circumferential direction on the basis of the rotation axis AX.

[Teeth]

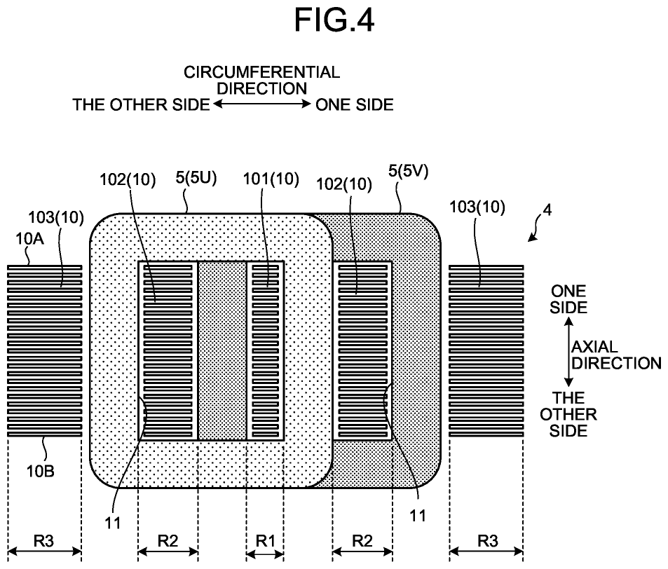

FIG. 4 is a diagram schematically illustrating the teeth 10 and the coils 5 according to the present embodiment. FIG. 4 corresponds to a diagram of the stator core 4 as viewed from the inside in the radial direction. As illustrated in FIGS. 3 and 4, the teeth 10 include first teeth 101 disposed in both the opening 11 of the U-phase coil 5U and the opening 11 of the V-phase coil 5V of the coil set 31, second teeth 102 disposed in one of the opening 11 of the U-phase coil 5U and the opening 11 of the V-phase coil 5V, and third teeth 103 not disposed in both the opening 11 of the U-phase coil 5U and the opening 11 of the V-phase coil 5V.

That is, the first teeth 101 are the teeth 10 disposed inside the openings 11 of two coils 5. The second teeth 102 are the teeth 10 disposed inside the opening 11 of one coil 5. The third teeth 103 are the teeth 10 that are not disposed inside the opening 11 of the coil 5.

The first teeth 101 include the teeth 10 disposed in both the opening 11 of the V-phase coil 5V and the opening 11 of the W-phase coil 5W of the coil set 32, and the teeth 10 disposed in both the opening 11 of the W-phase coil 5W and the opening 11 of the U-phase coil 5U of the coil set 33.

The second teeth 102 include the teeth 10 disposed in one of the opening 11 of the V-phase coil 5V and the opening 11 of the W-phase coil 5W of the coil set 32, and the teeth 10 disposed in one of the opening 11 of the W-phase coil 5W and the opening 11 of the U-phase coil 5U of the coil set 33.

The third teeth 103 include the teeth 10 that are not disposed in either the opening 11 of the V-phase coil 5V or the opening 11 of the W-phase coil 5W of the coil set 32, and the teeth 10 that are not disposed in both the opening 11 of the W-phase coil 5W and the opening 11 of the U-phase coil 5U of the coil set 33.

In other words, the first teeth 101 are the teeth 10 in which the end surface 10A and the end surface 10B face the two coils 5. The second teeth 102 are the teeth 10 in which an end surface 10A and an end surface 10B face the one coil 5. The third teeth 103 are the teeth 10 in which the end surface 10A and the end surface 10B do not face the coil 5.

As illustrated in FIG. 4, among the first teeth 101, the second teeth 102, and the third teeth 103, a dimension R1 of the first teeth 101 is the smallest, a dimension R2 of the second teeth 102 is the second smallest after the first teeth 101, and a dimension R3 of the third teeth 103 is the largest in the circumferential direction.

[Coil]

In the present embodiment, the coil 5 is formed of plate-shaped segment conductors. The segment conductors include a segment conductor constituting the U-phase coil 5U, a segment conductor constituting the V-phase coil 5V, and a segment conductor constituting the W-phase coil 5W.

The coil 5 is formed by spirally connecting the plurality of segment conductors. The U-phase coil 5U includes the plurality of segment conductors connected in a spiral shape. The V-phase coil 5V includes the plurality of segment conductors connected in a spiral shape. A part of the segment conductors of the V-phase coil 5V is disposed between the segment conductors of the U-phase coil 5U. The segment conductors of the U-phase coil 5U and the segment conductors of the V-phase coil 5V are alternately disposed in the radial direction. By arranging a part of the V-phase coil 5V between the U-phase coils 5U, the U-phase coil 5U and the V-phase coil 5V are overlapped with each other, and the coil set 31 of the U-phase coil 5U and the V-phase coil 5V is formed.

Similarly, by arranging a part of the W-phase coil 5W between the V-phase coils 5V, the V-phase coil 5V and the W-phase coil 5W are overlapped with each other, and the coil set 32 of the V-phase coil 5V and the W-phase coil 5W is formed. By arranging a part of the U-phase coil 5U between the W-phase coils 5W, the W-phase coil 5W and the U-phase coil 5U are overlapped with each other, and the coil set 33 of the W-phase coil 5W and the U-phase coil 5U is formed. The stator core 4 supports each of the coil set 31, the coil set 32, and the coil set 33.

Note that, in the present embodiment, the coil 5 is configured by the plate-shaped segment conductors, but may be configured by a round wire or may be configured by a rectangular wire.

[Manufacturing Method]

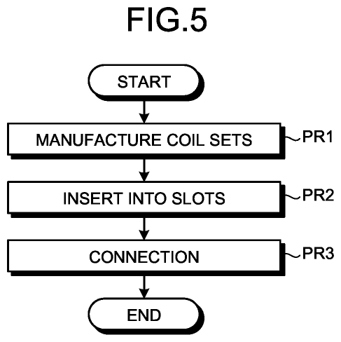

FIG. 5 is a flowchart illustrating an example of a method of manufacturing the stator 2 according to the present embodiment. As illustrated in FIG. 5, the stator 2 is manufactured by a manufacturing method including a process PR1 of manufacturing coil sets, a process PR2 of inserting the coil sets into the slots 9, and a process PR3 of connecting a plurality of the coil sets.

In the case of manufacturing the coil set 31, first, each of the U-phase coil 5U and the V-phase coil 5V is manufactured. The U-phase coil 5U is manufactured by connecting the plurality of segment conductors in a spiral shape. The V-phase coil 5V is manufactured by connecting the plurality of segment conductors in a spiral shape.

The plurality of segment conductors may be connected by welding or may be connected by pressure welding the end surfaces of the segment conductors.

After each of the U-phase coil 5U and the V-phase coil 5V is manufactured, a part of the segment conductors of the V-phase coil 5V is disposed between the segment conductors of the U-phase coil 5U. The U-phase coil 5U and the V-phase coil 5V are overlapped such that the segment conductors of the U-phase coil 5U and the segment conductors of the V-phase coil 5V are alternately disposed in the radial direction, whereby the coil set 31 of the U-phase coil 5U and the V-phase coil 5V is manufactured. Similarly, the coil set 32 of the V-phase coil 5V and the W-phase coil 5W and the coil set 33 of the W-phase coil 5W and the U-phase coil 5U are manufactured (Process PR1).

After the coil set 31, the coil set 32, and the coil set 33 are manufactured, each of the coil set 31, the coil set 32, and the coil set 33 is inserted into the slot 9 from the inside in the radial direction. As illustrated in FIG. 3, the coil set 33 is disposed on one side in the circumferential direction of the coil set 32, and the coil set 32 is disposed on one side in the circumferential direction of the coil set 31. One coil center portion 51 is disposed in each of the plurality of slots 9 (Process PR2).

After each of the coil set 31, the coil set 32, and the coil set 33 is inserted into the slot 9, the plurality of coils 5 are connected by a wire connection member (Process PR3).

Thus, the stator 2 is manufactured.

Note that the method of manufacturing the stator 2 described above is an example. When the coil 5 is formed of a round wire or a rectangular wire, the round wire or the rectangular wire may be wound around the teeth 10 using a nozzle that sends out the round wire or the rectangular wire.

### Advantageous Effects

As described above, according to the present embodiment, the motor 1 satisfies the conditions of the formulas (1) and (2). In the motor 1 with seven poles and 12 slots, the coils 5 can be disposed at a pitch of two slots. Therefore, the size of the coil end portion 52 can be suppressed.

For example, in a case where the coils are disposed at a pitch of three slots, as described in Patent Literature 1, three coils overlap at the coil end portion. As a result, the coil end portion becomes large. The coil end portion does not contribute to generation of torque of the motor 1. Therefore, when the coil end portion becomes large, the motor 1 increases in size although the torque generated by the motor 1 does not increase. As a result, the torque density of the motor 1 decreases. The torque density refers to a value obtained by dividing the torque that can be generated by the motor by the mass or volume of the motor. The torque density is preferably large.

According to the present embodiment, the number of the overlapping coils 5 in the coil end portion 52 is two. As illustrated in FIG. 2, some of the coil end portions 52 do not overlap with the other coil end portions 52. Accordingly, the coil end portion 52 is prevented from becoming large. Therefore, an increase in size of the motor 1 is suppressed.

Furthermore, for example, the motor 1 having the coils 5 disposed at a pitch of two slots can generate a larger torque than a motor having the coils disposed at a pitch of one slot. That is, by arranging the coils at a pitch of two slots, the motor 1 can generate a sufficient torque. Therefore, a decrease in the torque density of the motor 1 is suppressed.

Further, the coil pitch Ic of two slot pitches is smaller than the coil pitch of three slot pitches. Accordingly, according to the present embodiment, the phase resistance of the coils 5 is reduced as compared with the three slot pitches. Therefore, deterioration in performance of the motor 1 is suppressed.

Furthermore, in the present embodiment, by adopting the seven-pole 12-slot, it is possible to insert the coil set into the slot 9 from the inside in the radial direction after molding the coil set in which the two coils 5 are combined. According to the present embodiment, for example, the molded coils 5 (coil set) wound in a bobbin shape can be inserted into the slot 9 of the stator core 4 without adopting the split stator core. Therefore, the motor 1 can be easily manufactured.

In the present embodiment, the teeth 10 include the first teeth 101 disposed in the openings 11 of the two coils 5, the second teeth 102 disposed in the opening 11 of the one coil 5, and the third teeth 103 not disposed in the opening 11 of the coil 5. In the circumferential direction, the dimension R1 of the first teeth 101 is the smallest, the dimension R2 of the second teeth 102 is the second smallest after the first teeth 101, and the dimension R3 of the third teeth 103 is the largest. The inventor of the present invention has found that when the first teeth 101, the second teeth 102, and the third teeth 103 satisfy the condition of [R1<R2<R3], the torque generated by the motor 1 is improved. This is considered to be because when the stator 2 is designed to satisfy the condition of [R1<R2<R3], leakage of magnetic flux is reduced, and the magnetic flux can appropriately flow. When the condition of [R1<R2<R3] is satisfied, the motor 1 can generate a large torque.

In the rotation of the rotor 3, the coil pitch Ic and the pole pitch Ip are determined such that the two coil center portions 51 of the coil 5 and the two adjacent rotor core pieces 7 face each other, whereby the motor 1 can appropriately generate a torque.

### Other Embodiments

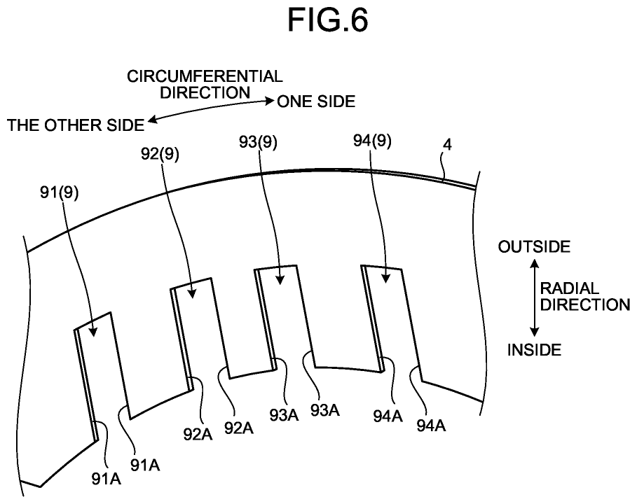

FIG. 6 is a diagram schematically illustrating the slot 9 according to the present embodiment. As illustrated in FIG. 6, in a cross section orthogonal to the rotation axis AX, an inner surface 91A of the first slot 91, an inner surface 92A of the second slot 92, an inner surface 93A of the third slot 93, and an inner surface 94A of the fourth slot 94 are parallel to each other. The inner surface of the slot 9 refers to a surface extending in each of the axial direction and the radial direction and facing the inner peripheral surface of the opening 11 of the coil 5.

As described above, for example, when the coil set 31 is inserted into the slot 9, the other coil center portion 51 of the U-phase coil 5U is disposed in the first slot 91, the other coil center portion 51 of the V-phase coil 5V is disposed in the second slot 92, one coil center portion 51 of the U-phase coil 5U is disposed in the third slot 93, and one coil center portion 51 of the V-phase coil 5V is disposed in the fourth slot. Since the inner surface 91A of the first slot 91, the inner surface 92A of the second slot 92, the inner surface 93A of the third slot 93, and the inner surface 94A of the fourth slot 94 have shapes close to parallel, the coil set 31 is smoothly inserted into the slot 9.

In the embodiment described above, the rotor 3 is disposed on the inner side (inner peripheral side) of the stator core 4, and the motor 1 is an inner rotor side motor. The rotor 3 may be disposed at a position facing the stator core 4. The motor 1 may be an outer rotor type motor in which the rotor 3 is disposed on the outer peripheral side of the stator core 4, a dual rotor type motor in which the rotor 3 is disposed on both the inner peripheral side and the outer peripheral side of the stator core 4, or an axial gap type motor in which the rotor 3 is disposed on a side of the axial direction of the stator core 4.

Note that, in the embodiment described above, the motor 1 is a segment-type switched reluctance motor. The motor 1 may be a switched reluctance motor provided with pole teeth, a synchronous reluctance motor, a flux switching motor, a permanent magnet motor, an induction motor, an axial gap motor, or a linear actuator.

In the above-described embodiment, the motor 1 is a three-phase motor. The motor 1 may be a four-phase motor. In this case, when the number of poles of the rotor is P, the number of slots of the stator core is S, and a natural number is N, the following conditions are satisfied:

P=5×N,

S=8×N.

### REFERENCE SIGNS LIST

1 MOTOR
2 STATOR
3 ROTOR
4 STATOR CORE
4A FIRST END SURFACE
4B SECOND END SURFACE
4S INNER PERIPHERAL SURFACE
4T OUTER PERIPHERAL SURFACE
5 COIL
5U U-PHASE COIL
5V V-PHASE COIL
5W W-PHASE COIL
6 ROTOR HOLDER
7 ROTOR CORE PIECE
8 SHAFT
9 SLOT
9A OPENING PORTION
9B OPENING PORTION
9M OPENING PORTION
10 TEETH
10A END SURFACE
10B END SURFACE
11 OPENING
31 COIL SET
32 COIL SET
33 COIL SET
51 COIL CENTER PORTION
52 COIL END PORTION
91 FIRST SLOT
91A INNER SURFACE
92 SECOND SLOT
92A INNER SURFACE
93 THIRD SLOT
93A INNER SURFACE
94 FOURTH SLOT
94A INNER SURFACE
101 FIRST TEETH
102 SECOND TEETH
103 THIRD TEETH
AX ROTATION AXIS
Ic COIL PITCH
Ip POLE PITCH
R1 DIMENSION
R2 DIMENSION
R3 DIMENSION
RS OBJECT

1. A motor comprising:
a stator core;
a coil disposed in slots of the stator core; and
a rotor facing the stator core,
wherein, when the number of poles of the rotor is P, the number of slots of the stator core is S, and a natural number is N, the following conditions are satisfied:
P=7×N,
S=12×N.

2. The motor according to claim 1, wherein
the stator core has teeth disposed between the slots adjacent to each other, and
the coil is disposed around the teeth at a pitch of two slots.

3. The motor according to claim 2, wherein
the coil includes a first-phase coil, a second-phase coil, and a third-phase coil,
a coil set of the first-phase coil and the second-phase coil is formed by disposing a part of the second-phase coil between the first-phase coils and disposing a part of the first-phase coil between the second-phase coils,
a coil set of the second-phase coil and the third-phase coil is formed by disposing a part of the third-phase coil between the second-phase coils and disposing a part of the second-phase coil between the third-phase coils,
a coil set of the third-phase coil and the first-phase coil is formed by disposing a part of the first-phase coil between the third-phase coils and disposing a part of the third-phase coil between the first-phase coils, and
the stator core supports the coil sets.

4. The motor according to claim 3, wherein
the teeth include first teeth disposed in both an opening of the first-phase coil and an opening of the second-phase coil, second teeth disposed in one of the opening of the first-phase coil and the opening of the second-phase coil, and third teeth not disposed in either the opening of the first-phase coil or the opening of the second-phase coil, and
in a circumferential direction, the first teeth have the smallest dimension, the second teeth have the second smallest dimension following the first teeth, and the third teeth have the largest dimension.

5. The motor according to claim 3, wherein
the coil includes two coil center portions disposed in the slots and a coil end portion axially protruding from the stator core, and
the slot includes a first slot in which one coil center portion of the first-phase coil is disposed, a second slot that is disposed adjacent to the first slot and in which one coil center portion of the second-phase coil is disposed, a third slot that is disposed adjacent to the second slot and in which the other coil center portion of the first-phase coil is disposed, and a fourth slot that is disposed adjacent to the third slot and in which the other coil center portion of the second-phase coil is disposed.

6. The motor according to claim 5, wherein
the two coil center portions of the first-phase coil and two of the poles adjacent to each other face each other in rotation of the rotor.
